(19) United States
(12) Patent Application Publication
(10) Pub. No.: US 2012/0050019 A1
(43) Pub. Date: Mar. 1, 2012

(54) TABLE TEK SYSTEMS

(76) Inventors: Margie E. Castro, Casa Grande, AZ (US); Raul F. Berlanga, Phoenix, AZ (US)

(21) Appl. No.: 13/211,497

(22) Filed: Aug. 17, 2011

Related U.S. Application Data
(60) Provisional application No. 61/378,222, filed on Aug. 30, 2010.

(51) Int. Cl. G08B 5/22

(52) U.S. Cl. 340/286.09

(57) ABSTRACT

An electronic communication system for increasing the efficiency of communication between restaurant patrons and wait-staff to enhance the dining experience using remotely connected communication devices. A communication device is used by patrons to electronically signal a desire to order, request service, or request a bill. Similarly, a communication device is worn by wait-staff to receive and acknowledge such requests.

### CROSS-REFERENCE TO RELATED APPLICATION

The present application is related to and claims priority from prior provisional application Ser. No. 61/378,222, filed Aug. 30, 2010 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### FIELD OF THE INVENTION

The present invention relates generally to the field of electronic communication devices and more specifically relates to electronic communication devices for use between patrons and wait-staff.

### DESCRIPTION OF THE RELATED ART

Many individuals in modern society dine in restaurants. Dine-in restaurants may be used to alleviate the stress of preparing one's own meal or for other guests. When dining in these restaurants, most patrons have at one time or another struggled to gain the attention of the wait-staff assigned to serve them. Whether they have a desire to place an order, change an order, request a service, or request a bill, patrons require the help of wait-staff throughout their dining experience. This may cause inconvenience and delay in the dining experience as the waiter/waitress may have various guests that need to be served as well as the waiter/waitress often needs to be in various locations within the restaurant, thus may be inaccessible at certain times. Short of a patron leaving the table to seek out the waiter/waitress, few options are available to alert a server that service is required.

Various attempts have been made to solve the above-mentioned problems such as those found in U.S. Pat. Nos. 6,636,835; 6,973,437; and 6,366,196. This prior art is representative of electronic communication devices. None of the above inventions and patents, taken either singly or in combination, is seen to describe the invention as claimed.

Ideally, an electronic communication device for use between patrons and wait-staff should be user-friendly and, yet, would operate reliably and be manufactured at a modest expense. Thus, a need exists for a reliable electronic communication system to promote communication between patrons and wait-staff to enhance the dining experience and to avoid the above-mentioned problems.

### BRIEF SUMMARY OF THE INVENTION

In view of the foregoing disadvantages inherent in the known electronic communication art, the present invention provides a novel Table Tek System. The general purpose of the present invention, which will be described subsequently in greater detail is to provide better communication between patrons and wait-staff to enhance the dining experience.

An electronic communication system for use between restaurant patrons and wait-staff is disclosed herein preferably comprising: at least one patron communication device and at least one wait-staff communication device. These patron communication device and wait-staff communication devices are preferably in remote wireless communication such that at least one message from a restaurant patron may be efficiently communicated to wait-staff. In preferred embodiments, the patron communication device may be table-mountable and the wait-staff communication devices are wearer-mountable.

In preferred embodiments the patron communication device may comprise a transceiver, a receiver, and a converter for the transmission of electronic signals. This device may also comprise a plurality of color-coded input buttons. These color-coded input buttons may include green, yellow, and red buttons (in other embodiments, other colors may be used). The green color-coded input button may be used to facilitate at least one order, the yellow color-coded input button may be used to indicate at least one service needed, and the red color-coded input button may be used to request a bill (check, ticket, tab or other.)

The wait-staff communication device may be wearable by wait-staff for convenience. This device may also comprise a receiver. The wait-staff communication device may also comprise an ear piece having a speaker and preferably a clip. To facilitate in receiving messages from a patron communication device, the wait-staff communication device may comprise a portable service device in communication with the ear piece. This portable service device may comprise an apparel clip, making it apparel-attachable in certain embodiments. This device may also comprise at least one indicator light and a vibrator for alerting wait-staff to incoming electronic signals.

Electronic messages sent from restaurant patron(s) may be remotely communicated to wait-staff using the present invention. Wait-staff may then respond remotely to a placed order. In order to accommodate a wider range of restaurant patrons, modifications may be made to these devices for the blind and hearing impaired (e.g., for example the patron communication device may contain Braille, and/or audible means and the like).

A method of using the electronic communication system for use between restaurant patrons and wait-staff is also described herein preferably comprising the steps of: activating the electronic communication system; (the patron) ordering at least one comestible; re-ordering at least one comestible or a service related to the comestible; and requesting a bill for paying.

The present invention holds significant improvements and serves as an electronic communication system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, Table Tek Systems, constructed and operative according to the teachings of the present invention.

FIG. 1 shows a perspective view illustrating an electronic communication system for use between restaurant patrons and wait-staff according to an embodiment of the present invention.

FIG. 2 is a perspective view illustrating the electronic communication system for use between restaurant patrons and wait-staff in an in-use condition according to an embodiment of the present invention of FIG. 1.

FIG. 3 is a perspective view illustrating the electronic communication system for use between restaurant patrons and wait-staff as a receiver with indicator lights and a display screen according to an embodiment of the present invention of FIG. 1.

FIG. 4 is a flowchart illustrating a method of use of the electronic communication system between restaurant patrons and wait-staff according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to electronic communication devices and more particularly to a Table Tek System 102 as used to improve the communication between restaurant patron(s) 130 and wait-staff 140 to enhance the dining experience.

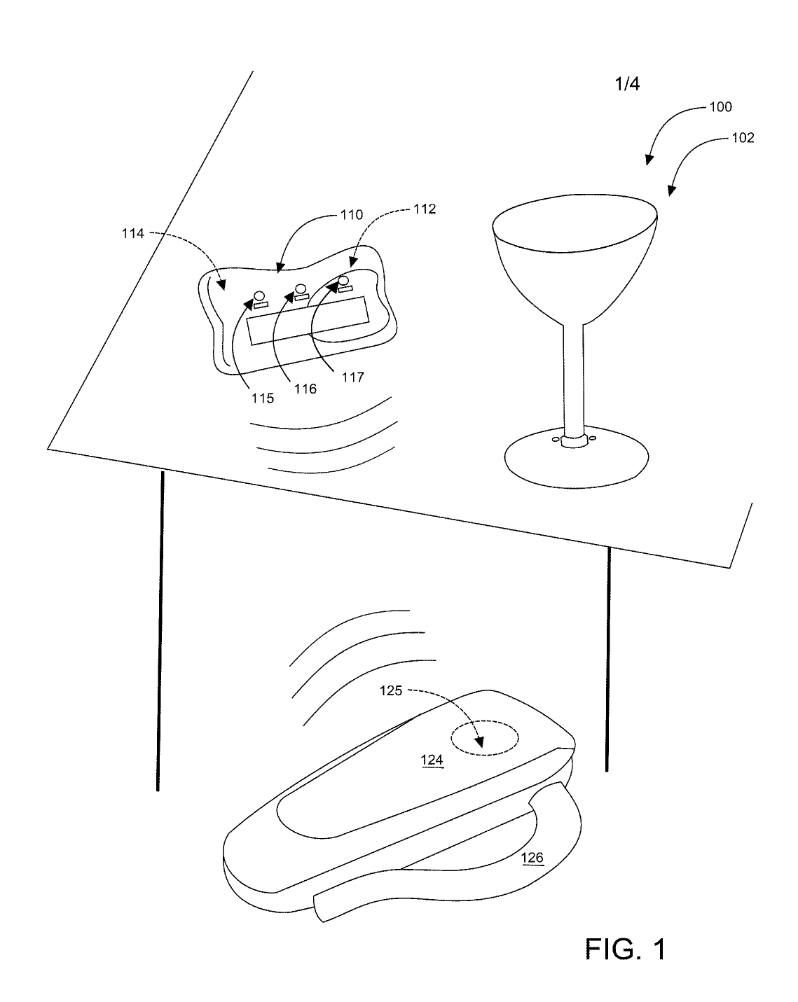

Referring to the drawings by numerals of reference there is shown in FIG. 1 a perspective view illustrating electronic communication system 100 for use between restaurant patron(s) 130 and wait-staff 140 according to an embodiment of the present invention.

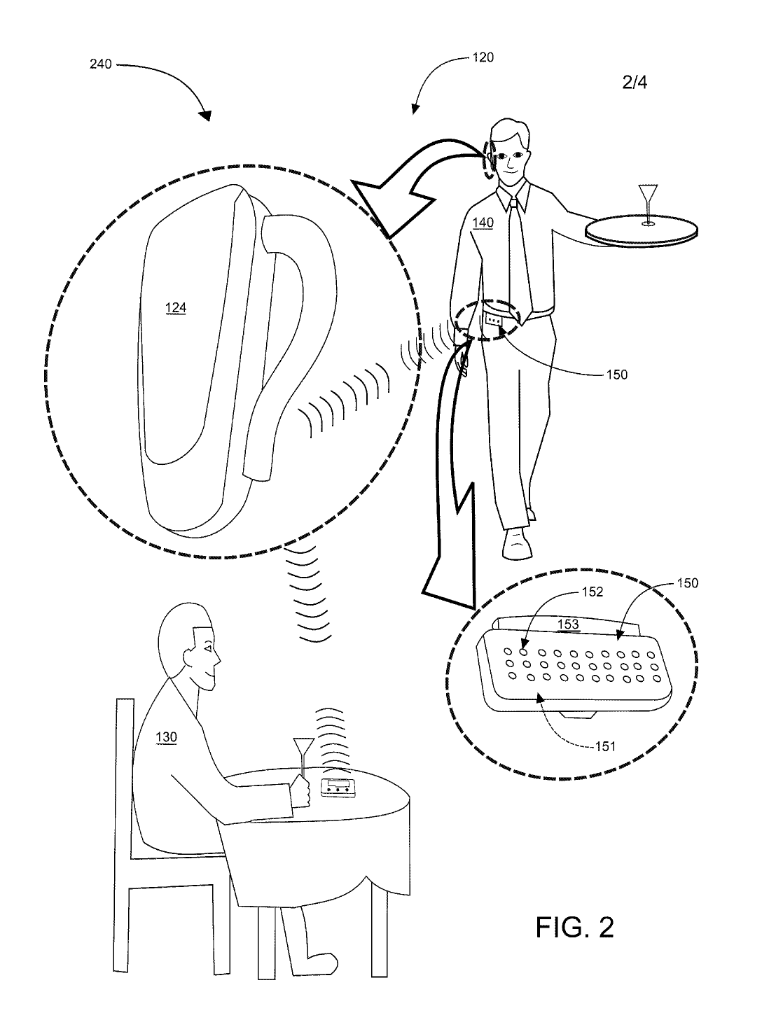

Electronic communication system 100 for use between restaurant patron(s) 130 and wait-staff 140 preferably comprises: at least one patron communication device 110; and at least one wait-staff communication device 120, wherein patron communication device 110 and wait-staff communication device 120 are preferably in remote wireless communication such that at least one message from restaurant patron(s) 130 may be communicated to wait-staff 140. Within this particular embodiment, patron communication device 110 may be table-mountable (as shown), and in other versions it may not be table-mountable. Wait-staff communication device 120, as shown in FIG. 2, is wearable by wait-staff 140; wherein a message from restaurant patron(s) 130 may be remotely communicated to wait-staff 140 such that wait-staff 140 may be able to remotely-respond to at least one placed-order or service request.

FIG. 2 is a perspective view illustrating electronic communication system 100 for use between restaurant patron(s) 130 and wait-staff 140 in an in-use condition according to an embodiment of the present invention of FIG. 1.

Patron communication device 110 preferably comprises a transceiver 112 which transmits electronic signals sent from restaurant patron(s) 130 to wait-staff 140 via wait-staff communication device 120. In order to eliminate redundancy, patron communication device 110 preferably comprises a converter 114 which directs electronic signals sent from restaurant patron(s) 130 along a specified frequency correlating (preferably only) to wait-staff communication device 110 matched to the individual patron communication device 110 transmitting the electronic signal. Those with ordinary skill in the art will now appreciate that upon reading this specification and by their understanding the art of converters, transceivers, receivers as described herein, methods of such electronic communication and means for producing that electronic communication between devices will be understood by those knowledgeable in such art.

Patron communication device 110 may comprise a plurality of color-coded input buttons by which restaurant patron(s) 130 submit order, service and bill requests to wait-staff 140. In preferred embodiments the color-coded input buttons comprise green, yellow and red buttons; however in alternate embodiments other colors may be used. Green color-coded input button 115 may be depressed by restaurant patron(s) 130 to facilitate at least one order. Yellow color-coded input button 116 in a similar manner may be depressed by restaurant patron(s) 130 to indicate at least one service need. Red color-coded input button 117 may be depressed by restaurant patron(s) 130 to request a bill. Indicia may be used on the device to promote ease of use.

Wait-staff communication device 120 may comprise an ear piece 124 in certain embodiments, wherein wait-staff 140 are relayed signals received from patron communication device 110 in an audible format through a speaker 125 of wait-staff communication device 120 ear piece 124. Ear piece 124 may be comprised of a clip 126 for fastening to wait-staff's 140 person. Clip 126 may be used to secure ear piece 124 to wait-staff's 140 person such that communication is enabled without disrupting or impeding freedom of movement. Upon reading this specification, it should be appreciated that, under appropriate circumstances, considering such issues as user preferences, design preference, structural requirements, marketing preferences, cost, available materials, technological advances, etc., other securing arrangements such as, for example, bands, VELCRO®, etc., may be sufficient.

Within this particular embodiment, wait-staff communication device 120 preferably comprises portable service device 150. Portable service device 150 may comprise apparel clip 128, as the device may be apparel-attachable such that it may be used by different wait-staff 140. In other embodiments, portable service device 150 may not be apparel-attachable. Also in this embodiment, portable service device 150 comprises a vibrator 129 for attracting the attention of wait-staff 140 to incoming electronic signals (without making noise.)

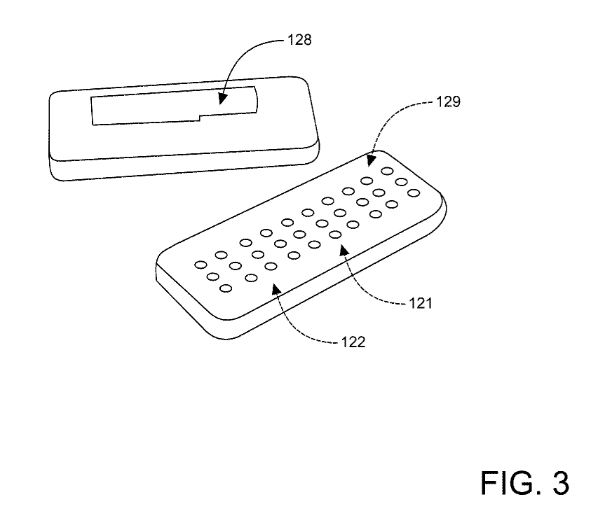

FIG. 3 is a perspective view illustrating electronic communication system 100 for use between restaurant patron(s) 130 and wait-staff 140 as a portable service device with receiver 151 and indicator light(s) 152 according to an embodiment of the present invention of FIG. 1.

Wait-staff communication device 120 preferably comprises portable service device 150, wherein receiver 151 receives, converts (via converter 121) and transmits (via transceiver 122) electronic signals sent from patron communication device 110 to ear piece124. In this way electronic signals may be converted to both visual and audible messages for wait-staff 140.

Indicator light(s) 152 are preferably used to visually designate which patron communication device 110 signaled and what type of service was requested by restaurant patron(s) 130. An apparel clip 153 allows portable service device 150 to be apparel-attached, while in other embodiments, portable service device 150 may not be apparel-attached. Ear piece124 may be inserted in or adjacent to the ear of wait-staff 140 such that an audible message may be heard. Ear piece124 may comprise a receiver suitable for converting an electronic input signal to an output audible signal.

In certain embodiments portable service device 150 may be used as an input device whereby wait-staff 140 may (remotely) indicate to restaurant patron130 that the requested service/product is in progress. For example input button(s) 115 (including green color-coded input button 115; yellow color-coded input button 116; and red color-coded input button 117) may be caused to blink or stay solid to indicate the order is in progress. Various blinking or solid or other means may be used to indicate various stages, responses, acknowledgement or the like, as per user-preference.

Electronic communication system 100 may be sold as kit 240 comprising the following parts: at least one patron communication device 110; at least one wait-staff communication device 120; at least one ear piece 124; and at least one set of user instructions. Electronic communication system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

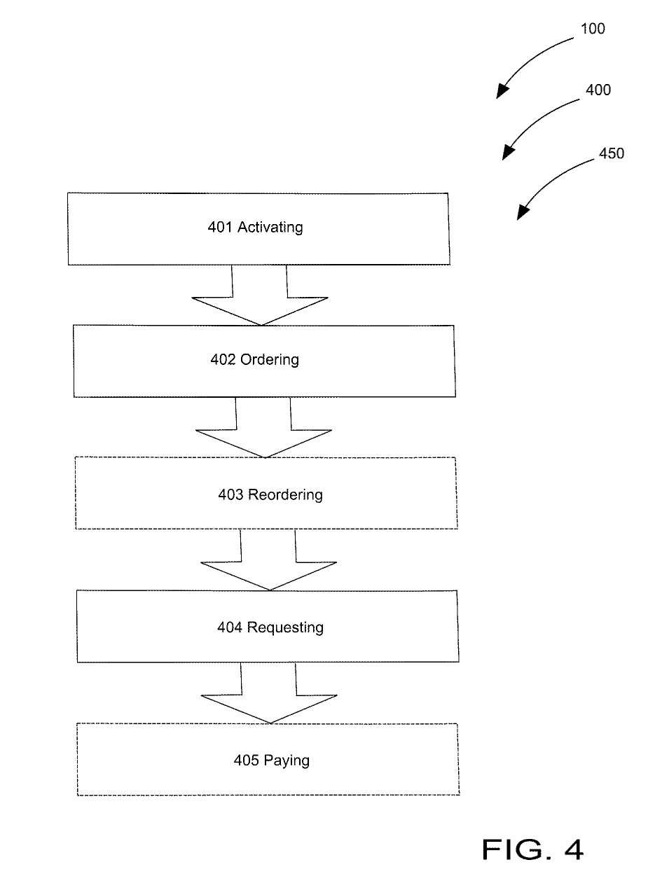

FIG. 4 is a flowchart 450 illustrating a method of use 400 of electronic communication system 100 for use between restaurant patrons 130 and wait-staff 140 according to an embodiment of the present invention of FIG. 1.

A method of using (at least hereby enabling method of use 400) an electronic communication system 100 for use between restaurant patrons 130 and wait-staff 140 preferably comprises the steps of: step one 401 activating electronic communication system 100; step two 402 (patron) ordering at least one comestible; step three 403 (patron) re-ordering at least one comestible or a service related to the comestible; step four 404 requesting a bill for paying; and step five 405 presenting payment of the bill. Optionally, as disclosed above wait-staff 140 may respond or acknowledge the service is in progress.

It should be noted that steps 403 and 405 are optional steps and may not be implemented in all cases. Optional steps of method 400 are illustrated using dotted lines in FIG. 4 so as to distinguish them from the other steps of method 400.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An electronic communication system for use between restaurant patrons and wait-staff comprising:
at least one patron communication device; and
a wait-staff communication device;
wherein said patron communication device and said wait-staff communication device are in remote wireless communication such that at least one message from said restaurant patron may be communicated to said wait-staff;
wherein said patron communication device is table-mountable;
wherein said wait-staff communication device is wearable by said wait-staff; and
wherein said message from said restaurant patron is remotely communicated to said wait-staff such that said wait-staff is able to remotely-respond to a placed-order.

2. The electronic communication system of claim 1 wherein said patron communication device comprises a transceiver.

3. The electronic communication system of claim 1 wherein said patron communication device comprises a receiver.

4. The electronic communication system of claim 1 wherein said patron communication device comprises a converter.

5. The electronic communication system of claim 4 wherein said patron communication device comprises a plurality of color-coded input buttons.

6. The electronic communication system of claim 5 wherein said converter comprises a green, a yellow and a red said color-coded input button.

7. The electronic communication system of claim 6 wherein said green color-coded input button is used to facilitate at least one order.

8. The electronic communication system of claim 6 wherein said yellow color-coded input button is used to indicate at least one service need.

9. The electronic communication system of claim 6 wherein said red color-coded input button is used to request a bill.

10. The electronic communication system of claim 1 wherein said wait-staff communication device comprises a receiver.

11. The electronic communication system of claim 1 wherein said wait-staff communication device comprises an ear piece.

12. The electronic communication system of claim 1 wherein said ear piece comprises a speaker.

13. The electronic communication system of claim 1 wherein said ear piece comprises a clip.

14. The electronic communication system of claim 1 wherein said wait-staff communication device comprises a portable service device.

15. The electronic communication system of claim 14 wherein said portable service device comprises an apparel clip.

16. The electronic communication system of claim 14 wherein said portable service device comprises at least one indication light.

17. The electronic communication system of claim 14 wherein said portable service device comprises a vibrator.

18. The electronic communication system of claim 15 wherein said portable service device is apparel-attachable.

19. An electronic communication system for use between restaurant patrons and wait-staff comprising:
at least one patron communication device; and
a wait-staff communication device;
wherein said patron communication device and said wait-staff communication device are in remote wireless communication such that at least one message from said restaurant patron may be communicated to said wait-staff;
wherein said patron communication device is table-mountable;
wherein said patron communication device comprises a transceiver;
wherein said patron communication device comprises a receiver;
wherein said patron communication device comprises a converter;
wherein said patron communication device comprises a plurality of color-coded input buttons including green, yellow and red said color-coded input buttons;
wherein said green color-coded input button is used to facilitate at least one order;
wherein said yellow color-coded input button is used to indicate at least one service need;
wherein said red color-coded input button is used to request a bill;
wherein said wait-staff communication device is wearable by said wait-staff;
wherein said wait-staff communication device comprises a receiver;
wherein said wait-staff communication device comprises an ear piece having a speaker, and a clip;
wherein said wait-staff communication device comprises a portable service device in communication with said ear piece and said patron communication device;
wherein said portable service device comprises an apparel clip;
wherein said portable service device comprises at least one indicator light and a vibrator;
wherein said portable service device is apparel-attachable; and
wherein said message from said restaurant patron is remotely communicated to said wait-staff such that said wait-staff is able to remotely-respond to a placed-order and respond with an acknowledgement that said placed-order is in progress.

20. A method of using an electronic communication system for use between restaurant patrons and wait-staff comprising the steps of:
activating said electronic communication system;
ordering at least one comestible;
re-ordering at least one comestible or a service related to said comestible; and
requesting a bill for paying.
